(19) United States
(12) Patent Application Publication
(10) Pub. No.: US 2002/0078468 A1
(43) Pub. Date: Jun. 20, 2002

(54) Data processor for outputting data according to their types

(76) Inventor: Minobu Yazawa, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/849,393

(22) Filed: May 7, 2001

(30) Foreign Application Priority Data
Dec. 20, 2000 (JP) 2000-387709

(51) Int. Cl. H04N 7/16

(52) U.S. Cl. 725/139; 725/142; 725/145; 725/151

(57) ABSTRACT

A data processor includes a first FIFO and a second FIFO. The first FIFO stores a plurality of types of cue data in a predetermined order, and the second FIFO stores, in parallel with the cue data stored in the first FIFO, the types of the cue data and information about continuity. A monitoring control circuit reads the plurality of cue data of the same type continuously from the first FIFO in response to the information stored in the second FIFO in parallel with the cue data. The back-end processor supplies the cue data to a memory as a single unit. The data processor can solve a problem of a conventional data processor in that it must incorporate FIFOs and FIFO monitoring circuits of the number equal to the number of the data types, and hence it is unavoidable that its circuit scale and cost increases with the number of data types.

### BACKGROUND OF THE INVENTION

1. Field of the Invention

The present invention relates to a data processor for temporarily storing a plurality of types of data transmitted, and for outputting the stored data in accordance with their types.

2. Description of Related Art

In the field of broadcasting or communications, video and sound data, and cue data are usually packetized, and the packets are transmitted in a mixed state. On the receiving side, such a system is configured that temporarily stores the transmitted packets in an external memory and processes the data as a single unit when the stored data reach a certain amount.

In this case, since the data transfer to the external memory on the receiving side involves overhead due to address switching, the data transfer word by word will increase the total overhead of the data transfer. Thus, it is preferable the data be transferred to as many consecutive addresses as possible in order to reduce the total overhead. For example, when the address switching involves overhead of 10 cycles, individual transfer of four words requires 44 (=(10+1)×4) cycles, but batch transfer requires only 14 (=10+1×4) cycles.

Here, a conventional data processor for writing the received data into a memory as a single unit will be described. FIG. 8 is a block diagram showing a configuration of a conventional data processor. In FIG. 8, the reference numeral 101 designates a FIFO (First-In First-Out) for inputting cue data #0; 102 designates a FIFO for inputting cue data #1; 111 designates a FIFO for inputting MPEG (Moving Picture Experts Group) composite data; 112 designates a FIFO for inputting an MPEG bit stream; 121 designates a FIFO for outputting video data; 122 designates a FIFO for outputting graphics data; 123 designates a FIFO for outputting an MPEG header; and 124 designates a FIFO for outputting sound data.

The reference -numeral 131 designates a FIFO monitoring circuit for monitoring the FIFO 101 to output the input data to the FIFO 101 as a single unit; 132 designates a FIFO monitoring circuit for monitoring the FIFO 102 to output the input data to the FIFO 102 as a single unit; 133 designates a FIFO monitoring circuit for monitoring the FIFO 111 to output the input data to the FIFO 111 as a single unit; and 134 designates a FIFO monitoring circuit for monitoring the FIFO 112 to output the input data to the FIFO 112 as a single unit. The reference numeral 141 designates a FIFO monitoring circuit for monitoring the FIFO 121 to output the input data to the FIFO 121; 142 designates a FIFO monitoring circuit for monitoring the FIFO 122 to output the input data to the FIFO 122; 143 designates a FIFO monitoring circuit for monitoring the FIFO 123 to output the input data to the FIFO 123; and 144 designates a FIFO monitoring circuit for monitoring the FIFO 124 to output the input data to the FIFO 124.

The reference numeral 161 designates a transfer circuit for writing data units supplied from the FIFOs 101, 102, 111 and 112 to an SDRAM 163, and for reading the data from the SDRAM 163 as single units, thereby supplying them to the FIFOs 121-124; 162 designates a control circuit for controlling the data transfer from the FIFO monitoring circuits 131-134 to the SDRAM 163, and from the SDRAM 163 to the FIFO monitoring circuits 141-144; and 163 designates the SDRAM (Synchronous Dynamic Random Access Memory) for storing various data that are received or processed by a processor not shown.

Next, the operation of the conventional data processor will be described.

The conventional data processor handles besides the MPEG bit stream and the like, the cue data #0 and #1 which are to be inserted into the received bit streams. The cue data #0 and #1 are supplied to the FIFOs 101 and 102 in accordance with their types, and are managed by the FIFO monitoring circuits 131 and 132 according to their types. The FIFO monitoring circuits 131 and 132 issue write/read requests for the external SDRAM in response to the states of the FIFOs 101 and 102. The control circuit 162 controls the requests to implement the write or read operation to or from the SDRAM 163.

With the foregoing configuration, the conventional data processor must comprise the FIFOs and the FIFO monitoring circuits by the number of types of the data. Thus, it has a problem in that its scale and cost will increase with the number of the data types.

Recently, the degree of integration of an LSI (Large Scale Integrated circuit) has been remarkably increasing. As a result, a single LSI can incorporate many circuits for carrying out various processings, which increases the types of data to be input thereto. Therefore, it is unavoidable that the section of the FIFOs and the FIFO monitoring circuits increases its size in the conventional data processor.

### SUMMARY OF THE INVENTION

The present invention is implemented to solve the foregoing problem. It is therefore an object of the present invention to provide a data processor capable of suppressing an increase in the circuit scale with the number of types of the data.

According to one aspect of the present invention, there is provided a data processor for temporarily storing a plurality of types of data transmitted, and for outputting stored data of each type as a single unit, the data processor comprising: first storing means for storing the plurality of types of data in a predetermined order; second storing means for storing information about the type of the data and information about continuity of data of a same type in parallel with the data stored in the first storing means; control means for reading a plurality of data of the same type continuously from the first storing means in response to the information stored in the second storing means; and output means for outputting the data read by the control means as a single unit.

Here, the control means may read the information about the type of the data and the information about continuity of the data of the same type from the second storing means in an order stored, and subsequently read the data corresponding to the information about the type of the data and the information about continuity of the data of the same type from the first storing means in response to the information read from the second storing means.

The first storing means may store, when reset information indicating a data type to be discarded is detected from the transmitted data, the reset information successively; the second storing means may store a reset flag with predetermined value in correspondence with the reset information; and the control means may start, when the reset information is detected from the transmitted data, to discard the data of the type specified by the reset information, read from the second storing means the information about the type of the data, the information about continuity of the data of the same type and the reset flag in the order stored, read the data and the reset information from the first storing means in the order stored, read, when reading the reset flag with the predetermined value from the second storing means, the reset information from the first storing means in synchronism with the reading of the reset flag from the second storing means, and complete discarding the data of the type specified by the reset information read from the first storing means.

The second storing means may successively store, when reset information indicating a data type to be discarded is detected from the transmitted data, the data type to be discarded and a start flag of a predetermined value in an order; and the control means may start, when the reset information is detected from the transmitted data, to discard data of the type specified by the reset information, read the information about the type of the data, the information about continuity of the data of the same type and the start flag from the second storing means in the order stored, and complete, when the start flag of the predetermined value is read from the second storing means, discarding the data indicated by the information about the type of the data read in conjunction with the start flag.

The first storing means may store, when reset information is detected in the transmitted data, a portion of the reset information in a predetermined order as a one word; the second storing means may store a reset flag ID indicating a position of the portion of the reset information in the reset information; and the control means may start, when the reset information is detected from the transmitted data, to discard the data of the type specified by the reset information, read from the second storing means the information about the type of the data, the information about continuity of the data of the same type, the reset flag and the reset flag ID in the order stored, read the data and the reset information from the first storing means in the order stored, read, when reading the reset flag with the predetermined value from the second storing means, the portion of the reset information from the first storing means in synchronism with the reading of the reset flag from the second storing means, and complete discarding the data of the type specified by the portion of the reset information read from the first storing means and the reset flag ID.

The second storing means may store, when same type data continue in the first storing means, a number of consecutive data in parallel with the data as information about continuity; and the control means may read the number of data from the second storing means, and read the data by the number of data continuously from the first storing means.

The second storing means may store, when same type data continue in the first storing means, stop information of a predetermined value in parallel with final data of the consecutive data as information about continuity; and the control means may read data and stop information corresponding to the data from the first storing means and the second storing means in synchronism, respectively, and read the data from the first storing means continuously until the stop information of the predetermined value is read from the second storing means.

The first storing means and second storing means may each consist of a FIFO.

### BRIEF DESCRIPTION OF THE DRAWINGS

FIG. 1 is a block diagram showing a configuration of an embodiment 1 of the data processor in accordance with the present invention;

FIG. 2 is a state transition diagram of the monitoring control circuit in the embodiment 1;

FIG. 3 is a timing chart illustrating the operation of resetting a 17th type of cue data;

FIG. 4 is a block diagram showing a configuration of an embodiment 2 of the data processor in accordance with the present invention;

FIG. 5 is a state transition diagram of the monitoring control circuit in the embodiment 2;

FIG. 6 is a block diagram showing a configuration of an embodiment 3 of the data processor in accordance with the present invention;

FIG. 7 is a block diagram showing a configuration of an embodiment 4 of the data processor in accordance with the present invention; and

FIG. 8 is a block diagram showing a configuration of a conventional data processor.

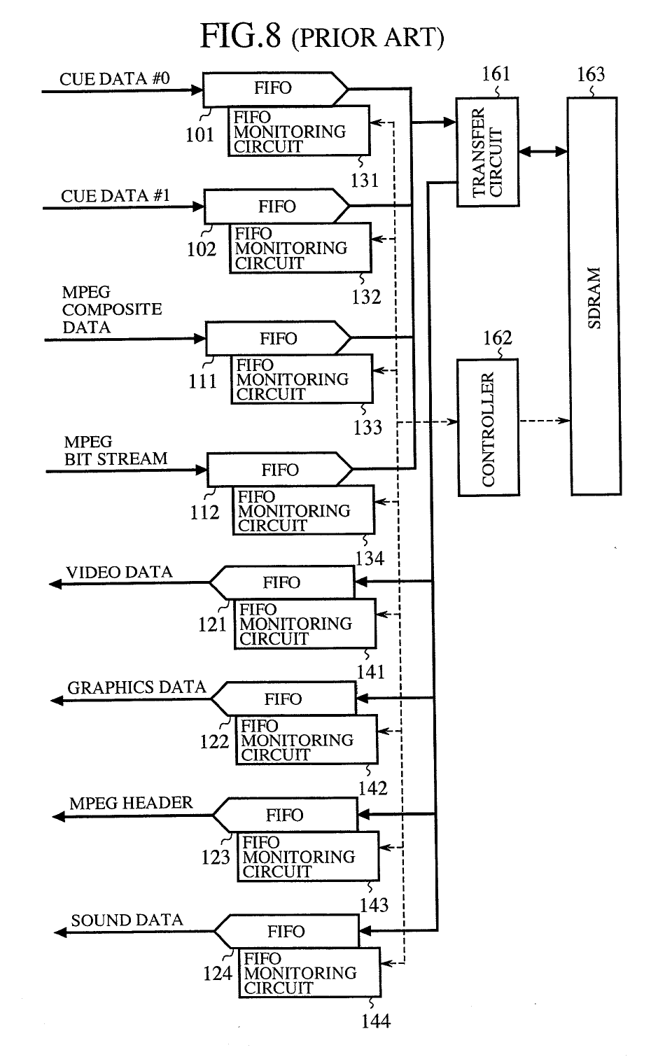

### DETAILED DESCRIPTION OF THE PREFERRED EMBODIMENTS

The invention will now be described with reference to the accompanying drawings.

Embodiment 1

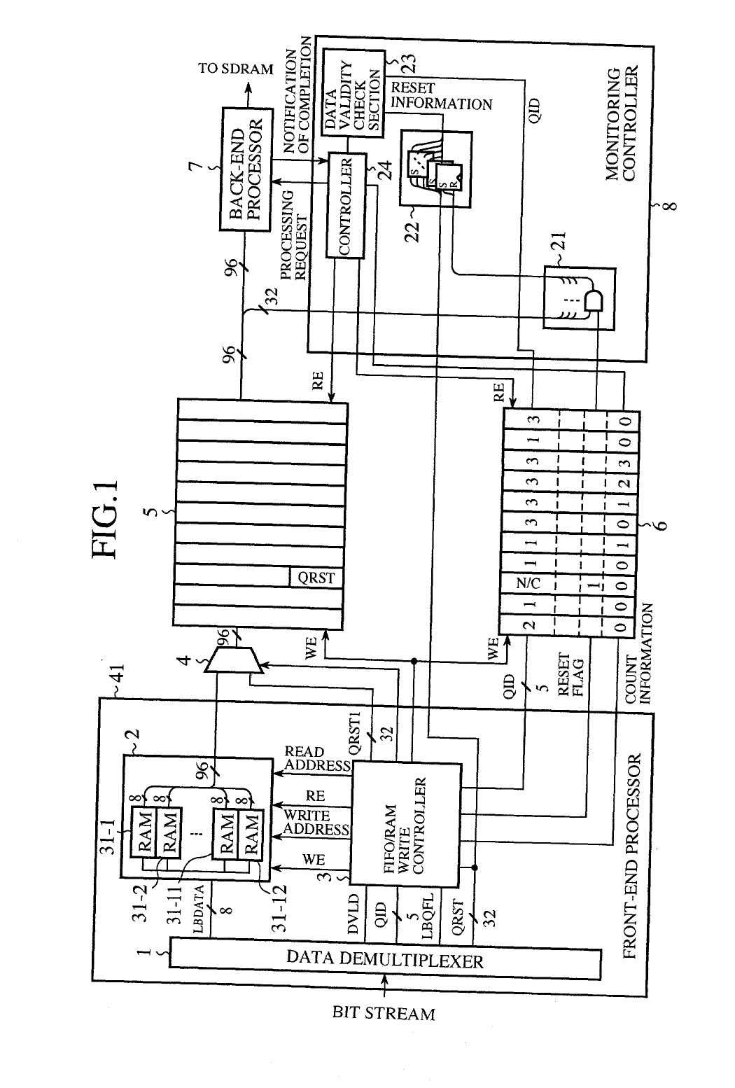

FIG. 1 is a block diagram showing a configuration of an embodiment 1 of the data processor in accordance with the present invention. In FIG. 1, the reference numeral 1 designates a data demultiplexer for demultiplexing a transmitted bit stream into cue data LBDATA, a valid signal DVLD indicating whether the transmitted data is cue data or not, a cue type QID indicating the type of the cue data, and reset information QRST indicating the cue type to be reset, and for outputting a signal LBQFL indicating a request for flashing (delivering) the data in a RAM 2 at the end of the cue data transmission.

The reference numeral 2 designates a serial-to-parallel converter memory that includes 12 RAMs 31-1-31-12 each storing a predetermined number of words (four words in this case) of the 8-bit cue data for each cue type, and converts the 8-bit cue data LBDATA to 96-bit cue data.

The reference numeral 3 designates a FIFO/RAM write controller for controlling the serial-to-parallel converter memory 2 and FIFOs 5 and 6 in response to the valid signal DVLD, cue type QID, signal LBQFL and reset information QRST1.

Here, the data demultiplexer 1, serial-to-parallel converter memory 2 and FIFO/RAM write controller 3 constitute a front-end processor 41.

The reference numeral 4 designates a selector for selecting either the cue data from the serial-to-parallel converter memory 2 or the reset information QRST1 from the FIFO/RAM write controller 3; 5 designates the FIFO for storing the cue data or the reset information; and 6 designates the FIFO for storing the cue type QID, a reset flag, count information and the like in parallel with the cue data or the reset information.

The reference numeral 7 designates a back-end processor for supplying the cue data from the FIFO 5 to a memory such as an SDRAM and to a processor in the subsequent stage, which are not shown in FIG. 1. The reference numeral 8 designates a monitoring control circuit for monitoring the validity of the cue data output from the FIFO 5, and the reset information about the cue data, and for controlling the back-end processor 7 in response to the monitored result.

In the monitoring control circuit 8, the reference numeral 21 designates a reset information selector for clearing the content of a reset information register 22 by the reset information QRST output from the FIFO 5 in response to the value of the reset flag; 22 designates the reset information register for storing the reset information QRST using SR flip-flops or JK flip-flops; 23 designates a data validity checking section for assuring the validity (reset state or not) of the cue data associated with the cue type QID output from the FIFO 6 by referring to the reset information in the reset information register 22; and 24 designates a controller for supplying the FIFOs 5 and 6 with an RE (read enabling) signal independently, and for controlling the back-end processor 7.

Next, the operation of the present embodiment 1 will be described.

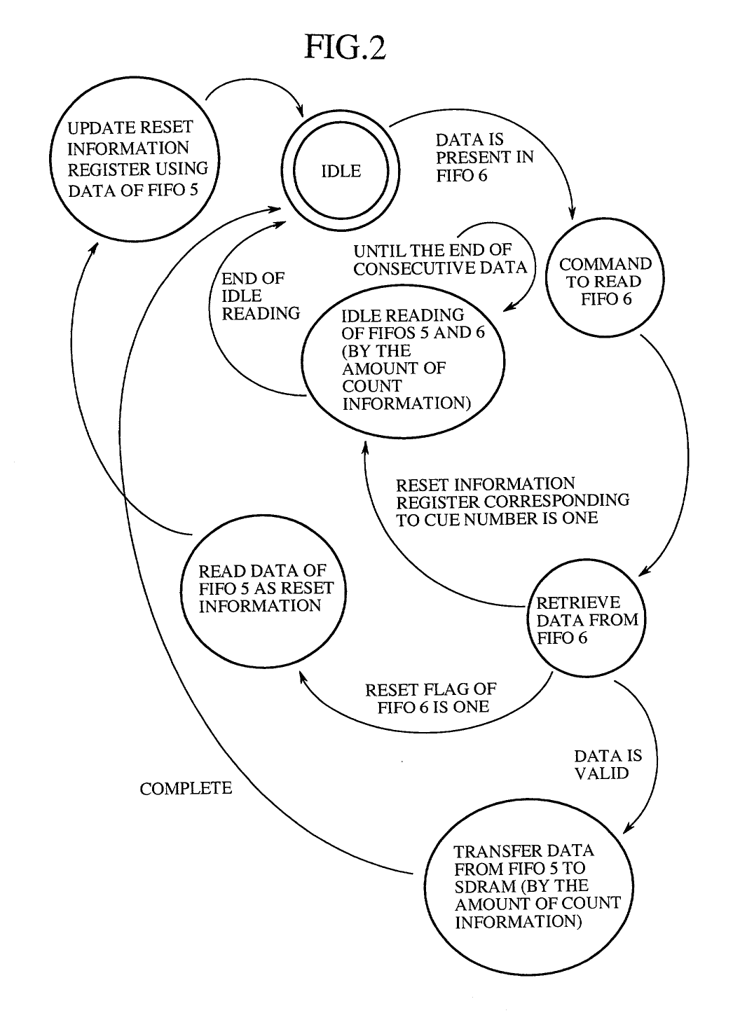

FIG. 2 is a state transition diagram of the monitoring control circuit 8 of the embodiment 1.

The data demultiplexer 1 extracts from the bit stream the cue data LBDATA, valid signal DVLD, cue type QID and reset information QRST, and supplies the cue data to the serial-to-parallel converter memory 2, and the valid signal DVLD and cue type QID to the FIFO/RAM write controller 3. When detecting a bit indicating the end of the data in the bit stream, the data demultiplexer 1 supplies the signal LBQFL to the FIFO/RAM write controller 3, and when detecting the reset information QRST, it supplies the reset information QRST to the FIFO/RAM write controller 3 and the monitoring control circuit 8.

Assume that the number of the cue types is 32. Then, the number of bits of the reset information QRST is also 32, and the number of bits of the cue type QID is five.

The FIFO/RAM write controller 3 writes the cue data LBDATA into the area corresponding to its cue type QID in one of the RAM 31-i by sequentially designating the RAM 31-i (i=1, . . . , 12) for storing the 8-bit cue data LBDATA, by supplying the serial-to-parallel converter memory 2 with the WE signal along with the write address of the memory area corresponding to the cue type QID.

For example, the cue data of the cue type QID=0 is assigned the addresses 00-03 of the RAMs 31-1-31-12, and the cue data of the cue type QID=1 is assigned the addresses 04-07 of the RAMs 31-1-31-12. The first cue data of the cue type QID=0 is written in the address 00 of the RAM 31-1, and the second cue data of the cue type QID=0 is written in the address 00 of the RAM 31-2. Likewise, each cue data of the cue type QID=0 is written in the address 00 of the RAM 31-3-31-12 successively. Then, the next cue data of the cue type QID=0 is written in the address 01 in the RAM 31-1. Thus, the cue data of the cue type QID=0 is written up to the address 03 of the RAM 31-12.

When the RAMs 31-1-31-12 store the cue data of the same cue type QID by an amount of 96 (=8×12) bits by four words, the FIFO/RAM write controller 3 causes each RAM to output the 4-word data by supplying the serial-to-parallel converter memory 2 with the RE signal and read address, and supplies the FIFO 6 with the count information corresponding to each word and the cue type QID of the word. The count information indicates the number of the remaining words of the cue data of the same cue type. For example, when four words continue, the count information about the first word is three, about the second word is two, about the third word is one and about the fourth word is zero.

The 4-word cue data output from the serial-to-parallel converter memory 2 is supplied to the FIFO 5 through the selector 4.

Then, the FIFO/RAM write controller 3 supplies the FIFOs 5 and 6 with the WE signal on the word by word basis so that the FIFO 5 stores the cue data word by word, and the FIFO 6 stores the cue type and the count information corresponding to the cue data of each word.

On the other hand, receiving the signal LBQFL indicating the request for flashing the data in the RAM 2 at the end of the cue data, the FIFO/RAM write controller 3 supplies the serial-to-parallel converter memory 2 with the RE signal and the read address to cause the converter memory 2 to output the data stored up to that time, even though the cue data is less than four words. In this case, the FIFO/RAM write controller 3 also supplies the FIFO 6 with the cue type QID and the count information on each of the words. For example, when the signal LBQFL is supplied at the time when 48-bit cue data is written, the 48-bit cue data is output as a one word, and the count information corresponding to the word is placed at zero.

Thus supplying the WE signal word by word from the FIFO/RAM write controller 3 to the FIFOs 5 and 6 allows the FIFO 5 to store the cue data, and the FIFO 6 to store the cue type and the count information corresponding to the cue data.

Shifting the stored contents word by word every time the WE signal is supplied, the FIFOs 5 and 6 output the stored data in a first-in first-out order.

On the other hand, the monitoring control circuit 8 monitors whether the FIFO 6 includes data or not as illustrated in FIG. 2, and allows the back-end processor 7 to capture the cue data from the FIFO 5 in response to the information from the FIFO 6, and writes the cue data in the SDRAM not shown.

In the course of this, the controller 24 supplies the FIFO 6 with the RE signal to read the cue type and the like of the cue data. The data validity checking section 23 reads from the reset information register 22 the reset information corresponding to the cue type read from the FIFO 6, and checks the validity of the cue data stored in the FIFO 5 in response to the reset information, thereby notifying the controller 24 of the result. In response to the count information read from the FIFO 6 and the data validity information fed from the data validity checking section 23, the controller 24 controls such that the FIFO 5 outputs the cue data continuously and stores the cue data in the SDRAM, as long as the effective cue data of the same cue type continue.

In this way, the single FIFO 5 temporarily stores a plurality of types of the cue data, and outputs the continuous cue data of the same type as a single unit in response to the information about the individual cue data, which is stored in the FIFO 6, thereby storing the cue data in the SDRAM.

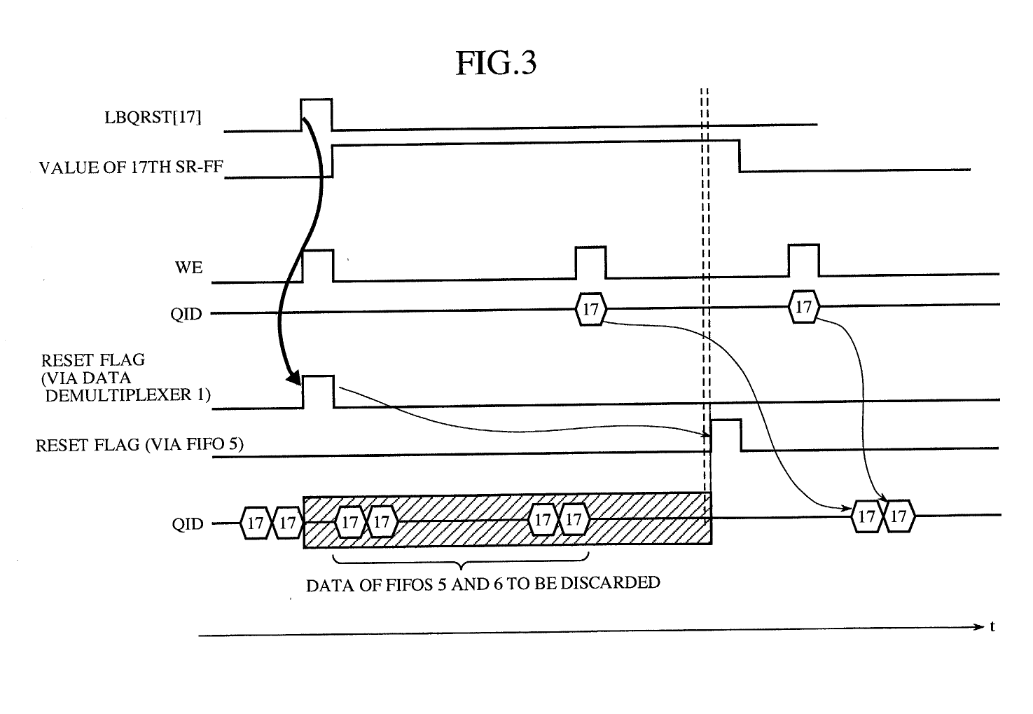

Next, the operation will be described for resetting the content of the FIFO 5 for each cue type independently. Since the present embodiment 1 uses the FIFO 5 to store a plurality of types of the cue data, simply supplying the reset signal to the FIFO 5 will reset all the types of the cue data in the FIFO 5 at once. In view of this, the present embodiment 1 enables the cue data to be reset (discarded) for each cue type separately. FIG. 3 is a timing chart illustrating the reset operation of the 17th type of the cue data.

To reset the cue data of a predetermined cue type, the data demultiplexer 1 extracts the reset information QRST from the bit stream, and supplies it to the FIFO/RAM write controller 3. The reset information QRST consists of the bits each assigned to one of the cue types, and the bit corresponding to the cue type to be reset is placed at one.

In response to the reset information QRST including at least one bit with the value one, the FIFO/RAM write controller 3 supplies the selector 4 with the reset information QRST1, and controls the selector 4 so that it supplies the reset information to the FIFO 5. At the same time, the FIFO/RAM write controller 3 supplies the FIFO 6 with the reset flag with the value one. In this case, it is not necessary to refer to the cue type QID. To show that the cue type QID can be a don't care signal, it is denoted by the “N/C” in FIG. 1.

Then, the FIFO/RAM write controller 3 supplies the WE signal to the FIFOs 5 and 6 so that the FIFO 5 records the reset information QRST, and the FIFO 6 records the reset flag with the value one corresponding to the reset information QRST.

In addition, the reset information QRST is supplied from the data demultiplexer 1 to the reset information register 22 in the monitoring control circuit 8 to be recorded. The reset information register 22 consists of SR flip-flops whose number is equal to the number of bits of the reset information QRST (32, in this case), so that the SR flip-flops hold the reset information QRST.

The data validity checking section 23 in the monitoring control circuit 8 refers to the reset information stored in the reset information register 22 to make a decision as to whether to discard the cue data associated with the cue type QID read from the FIFO 6. When discarding the cue data with the cue type QID, the controller 24 carries out idle reading of the data with establishing synchronization between the FIFO 5 and FIFO 6, thereby discarding the continuous cue data of the cue type. Since the reset information is read in advance from the FIFO 6, the idle reading of the FIFO 6 is reduced by one time.

When the value of the reset flag from the FIFO 6 becomes one, the reset information selector 21 resets the reset information register 22 in response to the output of the FIFO 5 at that time, that is, to the reset information recorded previously, thereby clearing the reset state of the cue type. For example, the reset information selector 21 consists of 32 AND circuits, each having its first input connected to the reset flag, and its second input connected to one of the reset information bits, so that the reset information selector 21 supplies the reset information to the reset information register 22 only when the value of the reset flag is one.

In the course of this, when the FIFO 5 supplies the reset information to the reset information register 22 through the reset information selector 21, the values held by the SR flip-flops in the reset information register 22 are reset because the reset information is identical to the reset information stored in the reset information register 22, thereby releasing it from the discard request state to the normal state. For example, when the first and second cue types are to be reset, the reset information QRST is supplied from the data demultiplexer 1 to the SR flip-flops in the reset information register 22, thereby placing the values of the first and second SR flip-flops at one. Subsequently, when the same reset information, which passes through the FIFO 5, is supplied to the SR flip-flops in the reset information register 22, the values held by the first and second SR flip-flops are returned to the normal value zero. FIG. 3 illustrates the change in the value of the 17th SR flip-flop, when the 17th cue data is reset.

Thus, the cue data with the cue type corresponding to the reset state is discarded over the period, during which the reset information passes through the FIFO 5.

As described above, according to the present embodiment 1, the FIFO 5 stores the multiple types of cue data in sequence, and the FIFO 6 stores the cue type and the count information corresponding to the cue data stored in the FIFO 5; the monitoring control circuit 8 reads the multiple cue data of the same type from the FIFO 5 in response to the information stored in the FIFO 6; and the back-end processor 7 outputs the cue data read from the monitoring control circuit 8 as a single unit. As a result, the present embodiment 1 offers an advantage of being able to write cue data efficiently using a circuit with a fixed scale specified, even when the number of types of the cue data is large.

In addition, according to the present embodiment 1, the monitoring control circuit 8 successively reads the cue types QID in the sequence they are recorded in the FIFO 6, and subsequently reads from the FIFO 5 the cue data corresponding to one of the cue types QID. Accordingly, the present embodiment 1 can make a decision as to the processing of the cue data stored in the FIFO 5 in response to the information previously read from the FIFO 6. As a result, the present embodiment 1 can eliminate the storing means conventionally needed for storing the data output from the FIFO 5 until the decision as to the processing is made when the data are read simultaneously from the FIFOs 5 and 6, thereby offering an advantage of being able to reduce the circuit scale.

Furthermore, according to the present embodiment 1, when the reset information is detected, the FIFO 5 records the reset information; the FIFO 6 stores the reset flag with a specified value in response to the reset information; and the monitoring control circuit 8 starts to discard the cue type specified by the reset information when it is detected, and reads, when it reads the reset flag with the specified value from the FIFO 6, the reset information from the FIFO 5 in synchronism with the reading from the FIFO 6, thereby terminating the discarding of the cue type specified by the reset information read from the FIFO 5. As a result, the present embodiment 1 offers an advantage of being able to implement the reset of the cue data with the specified cue type by a simple processing.

Moreover, according to the present embodiment 1, when the cue data of the same type continues in the FIFO 5, the FIFO 6 memorizes the number of continuous data (count information) corresponding to the cue data as the continuity information; and the monitoring control circuit 8 reads the data with that data number continuously from the FIFO 5. Accordingly, the present embodiment 1 can offer an advantage of being able to learn the number of words to be read continuously, facilitating optimizing the processing.

Embodiment 2

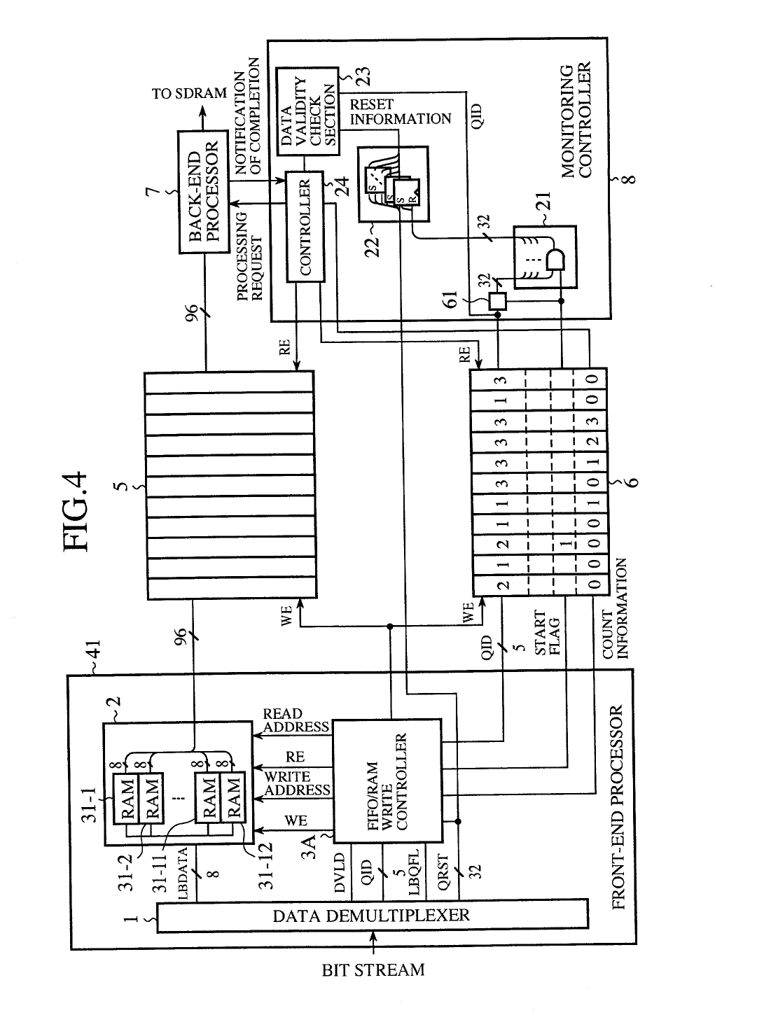

The present embodiment 2 of the data processor in accordance with the present invention is configured such that the reset state is maintained until the FIFO 6 outputs a start flag of the cue type to be discarded without writing the reset information into the FIFO 5. FIG. 4 is a block diagram showing a configuration of the embodiment 2 of the data processor in accordance with the present invention. In FIG. 4, the reference numeral 3A designates a FIFO/RAM write controller that operates in the same manner as the FIFO/RAM write controller 3 except that it supplies the FIFO 6 with a start flag instead of the reset flag; and 61 in the monitoring control circuit 8 designates a reset signal generator for supplying, when the FIFO 6 outputs the start flag with a predetermined value, the reset information selector 21 with the reset signal that has the same number of bits as the reset information (32, in this case), and assigns the predetermined value only to the bit corresponding to the cue type QID output from the FIFO 6.

Since the remaining components of FIG. 4 are the same as those of the foregoing embodiment 1, the description thereof is omitted here. In the present embodiment 2, however, the cue type to be reset is written into the FIFO 6 along with the start flag. In the example as shown in FIG. 4, the second cue type is reset.

Next, the operation of the present embodiment 2 will be described.

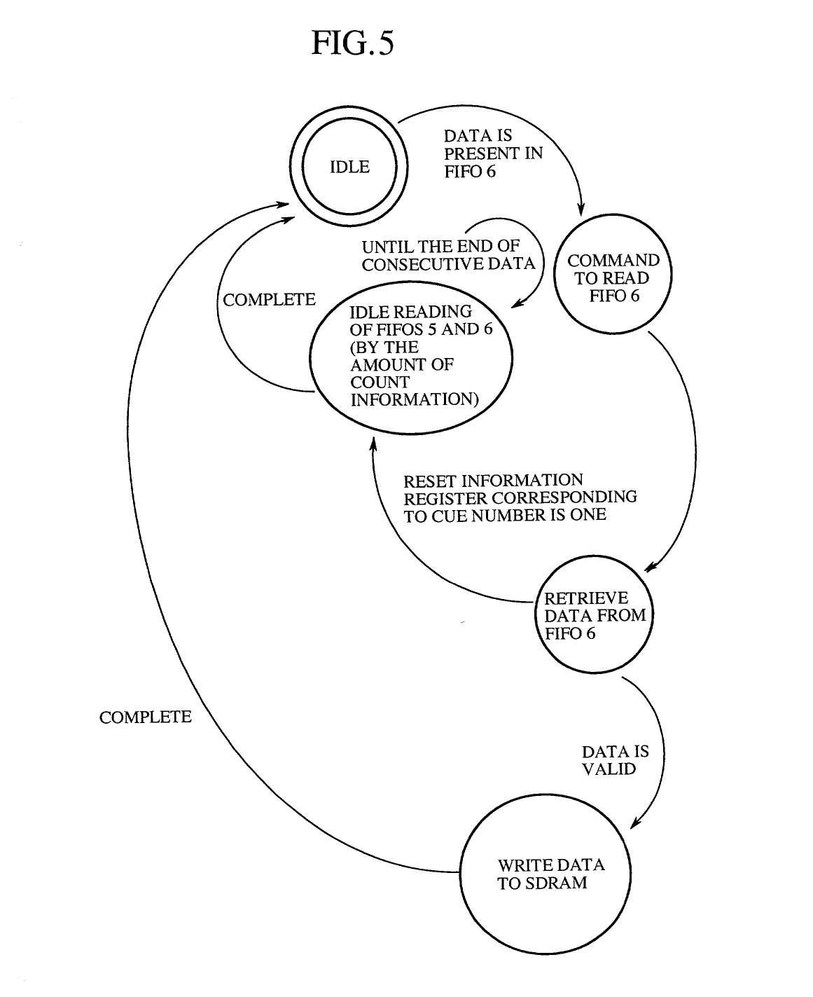

FIG. 5 is a state transition diagram of the monitoring control circuit in the present embodiment 2.

Since the operation of the present embodiment 2 is the same as that of the foregoing embodiment 1 except for the reset of the cue data, the description thereof is omitted here.

To discard particular cue data, its reset information QRST is recorded in the reset information register 22, and the start flag with the value one and the cue type to be reset are written into the FIFO 6.

Subsequently, when the monitoring control circuit 8 reads the start flag with the value one from the FIFO 6, the reset signal generator 61 supplies the reset information selector 21 with the 32-bit reset signal with its bit corresponding to the cue type QID read from the FIFO 6 being placed at one. Since the value of the start flag is one, the reset signal is supplied to the reset information register 22 via the reset information selector 21, so that the content of the reset information register 22 is updated, and the cue type is returned from the discard state to the normal state.

Although the present embodiment 2 is a variation of the foregoing embodiment 1, the following embodiments can be modified in the same manner.

As described above, according to the present embodiment 2, when the reset information is detected, the FIFO 6 records the cue type QID specified to be discarded by the reset information and the start flag with the particular value; and the monitoring control circuit 8 starts, when the reset information is detected, the cue data associated with the cue type specified by the reset information, and completes, when it reads the start flag with the predetermined value from the FIFO 6, discarding the cue data indicated by the cue type QID read along with the start flag. As a result, the present embodiment 2 can eliminate the need for writing the reset information into the FIFO 5, which offers an advantage of being able to obviate the means (selector 4) for selecting either the reset information or the cue data. Thus, the present embodiment 2 can reduce the scale of the circuit, and suppress the delay of the processing due to the means.

Embodiment 3

The embodiment 3 of the data processor in accordance with the present invention is configured such that it writes a predetermined portion (16 bits, for example) of the reset information (32 bits, for example) to the FIFO 5 as a one word; and decides the position of the predetermined portion in the reset information output from the FIFO 5 in accordance with the value of a reset flag ID, thereby making it possible to return the reset state of the cue type information to the normal state even when the number of the cue types is greater than the number of bits of the word width of the FIFO 5.

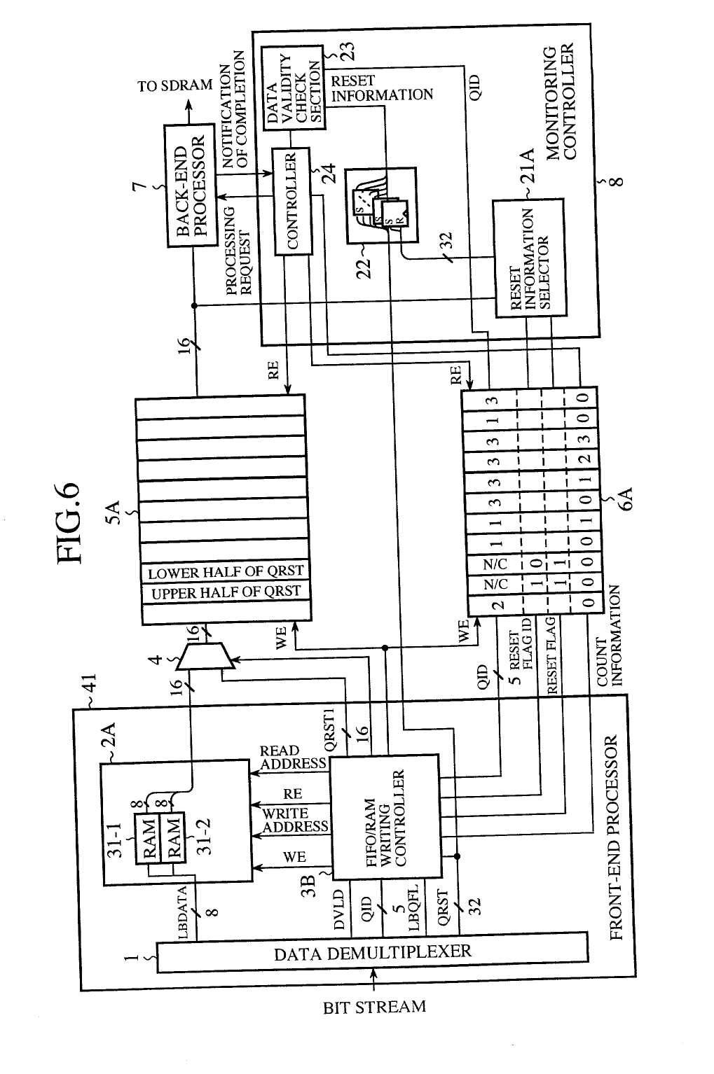

FIG. 6 is a block diagram showing a configuration of the embodiment 3 of the data processor in accordance with the present invention. In FIG. 6, the reference numeral 2A designates a serial-to-parallel converter memory that includes two RAMs 31-1 and 31-2, and converts the 8-bit cue data LBDATA to 16-bit cue data to be output.

The reference numeral 3B designates a FIFO/RAM write controller that operates in the same manner as the FIFO/RAM write controller 3 except for the following. First, it supplies a FIFO 6A with the reset flag ID indicating whether the portion of the reset information QRST, which is to be written into the FIFO 5A in parallel with the cue type to be reset in response to the reset information during the reset operation, is the upper half or lower half of the reset information. Second, it supplies the selector 4 with the upper half bits or lower half bits of the reset information QRST in response to the value of the reset flag ID.

The reference numeral 5A designates a FIFO, the number of bits of each word of which (16 bits, in the example) is less than the number of the cue types (32 in the example); and 6A designates a FIFO for holding the cue type QID, the reset flag ID, the reset flag and the count information as one word.

The reference numeral 21A designates a reset information selector for generating a reset signal with the same number of bits as the original reset information QRST by adding the remaining portion of the reset information with a value of zero to the reset information consisting of the upper half or lower half output from the FIFO 5A in response to the value of the reset flag ID when the value of the reset flag is at the specified value, thereby resetting the content of the reset information register 22 by the reset signal.

Since the remaining components of FIG. 6 are the same as those of the foregoing embodiment 1, the description thereof is omitted here.

Next, the operation of the present embodiment 3 will be described.

In the present embodiment 3, the following description is made assuming that the number of the cue types is 32, and the number of the bits of the word width of the FIFO 5A is 16.

The serial-to-parallel converter memory 2A stores the 8-bit cue data LBDATA into the two RAMs 31-1 and 31-2 in the same sequence as the serial-to-parallel converter memory 2 does, and outputs 16-bit×4-word cue data. When all the cue types are effective, that is, no cue type is discarded, the selector 4 supplies the 16-bit cue data to the FIFO 5A.

Thus, the cue data is written into the FIFO 5A, and the cue type QID, the reset flag ID, the reset flag with the value zero and the count information are written into the FIFO 6A as in the foregoing embodiment 1. When the cue data is written into the FIFO 5A, the reset flag ID can take any value.

The monitoring control circuit 8 controls the back-end processor 7 in the same manner as that of the embodiment 1 so that the effective cue data output from the FIFO SA is written into the SDRAM in response to the reset information in the reset information register 22 and the cue type QID fed from the FIFO 6A.

The operation thus outputting the cue data and writing it into the SDRAM is analogous to that of the foregoing embodiment 1.

Next, the operation of resetting the content of the FIFO 5A for each cue type separately will be described.

To discard the cue data of a particular cue type, the reset information QRST including a bit of a value one is supplied from the data demultiplexer 1 to the reset information register 22 and the FIFO/RAM write controller 3B.

In response to the cue type to be discarded specified by one of the bits of the 32-bit reset information QRST, the FIFO/RAM write controller 3B sets the value of the reset flag ID, and supplies the reset flag ID to the FIFO 6A.

The reset flag ID indicates whether the portion of the reset information to be written into the FIFO 5A is the upper half or lower half of the reset information. Specifically, when at least one cue type to be discarded belongs in the first to 16th cue type, the reset flag ID is placed at zero, whereas when at least one cue type to be discarded belongs in the 17th to 32nd cue type, the reset flag ID is placed at one.

When the value of the reset flag ID is zero, the FIFO/RAM write controller 3B selects the lower 16 bits of the 32-bit reset information. On the contrary, when the value of the reset flag ID is one, it selects the upper 16 bits of the 32-bit reset information. The selected 16-bit data is written into the FIFO 5A via the selector 4.

In synchronism with that, the reset flag ID and the reset flag with the value one are written into the FIFO 6A.

After that, when the monitoring control circuit 8 reads the reset flag with the value one from the FIFO 6A, the reset information selector 21A generates the 32-bit reset signal from the 16-bit reset information output from the FIFO 5A in response to the value of the reset flag ID output simultaneously.

Specifically, when the value of the reset flag ID is zero, the reset information selector 21A generates the 32-bit reset signal by making its lower 16 bits equal to the 16-bit reset information output from the FIFO 5A, and by adding the upper 16 bits of zero to the lower 16 bits. In contrast, when the value of the reset flag ID is one, the reset information selector 21A generates the 32-bit reset signal by making the upper 16 bits equal to the 16-bit reset information output from the FIFO 5A, and by adding the lower 16 bits of zero to the upper 16 bits.

Then, the reset information register 22 clears its value in response to the 32-bit data from the reset information selector 21A, thereby returning the cue type from the discarding state to the normal state.

Incidentally, when both the upper and lower 16 bits of the reset information include the cue type to be discarded, the respective 16-bit data of the reset information can be written at two times as illustrated in FIG. 6.

Although the original reset information QRST is divided into the upper half bits and lower half bits in the present embodiment 3, this is not essential. For example, it can be divided such that the cue types associated with each other belong to the same block.

In addition, although the present embodiment 3 is a variation of the embodiment 1, other embodiments can be modified in the same manner.

As described above, the present embodiment 3 is configured such that when the reset information is detected, the FIFO 5A sequentially stores the portion of the reset information as one word; the FIFO 6A stores the reset flag ID indicating the position of that portion in the reset information; and the monitoring control circuit 8 starts discarding the data of the type specified by the reset information at the detection of the reset information, and completes, when reading the reset flag of the specified value from the FIFO 6A, discarding the data of the type specified by the portion of the reset information and the reset flag ID by reading the portion of the reset information from the FIFO 5A in synchronism with the reading of the reset flag from the FIFO 6A. Thus, the present embodiment 3 offers an advantage of being able to write the cue data into the memory efficiently with a predetermined circuit scale, even if the number of the types of the cue data is greater the number of bits of the word width of the FIFO 5A.

Embodiment 4

The embodiment 4 of the data processor in accordance with the present invention is configured such that it writes 1-bit stop information into a FIFO 6B instead of the count information. The stop information takes a different value only when the final cue data takes place in the consecutive cue data of the same type. Then, it decides the final position of the same cue type in response to the stop information.

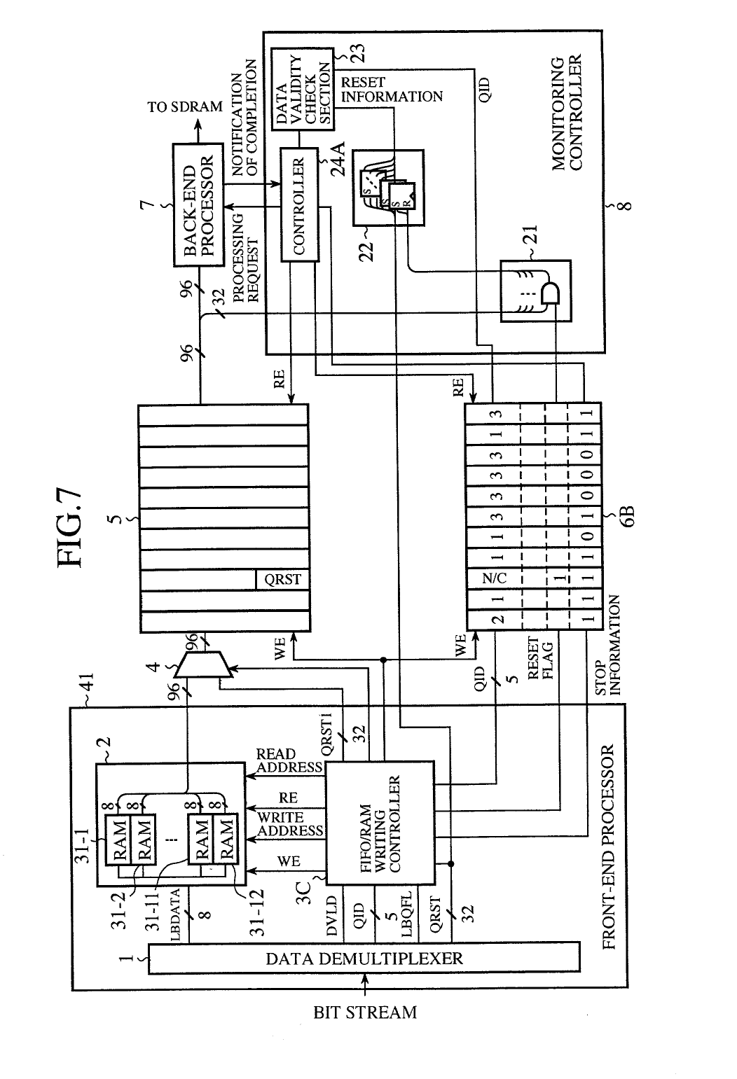

FIG. 7 is a block diagram showing a configuration of an embodiment 4 of the data processor in accordance with the present invention. In FIG. 7, the reference numeral 3C designates a FIFO/RAM write controller that operates in the same manner as the FIFO/RAM write controller 3 except for the following: When the cue data of the same cue type continue, it supplies the FIFO 6B with the stop information that takes the value zero for the cue data other than the final cue data of the consecutive cue data, and that takes the value one for the final cue data, as information about continuity.

The reference numeral 24A designates a controller, the basic operation of which is the same as that of the controller 24, but which causes the FIFO 5 to output the cue data of the same cue type until the stop information takes the value one, and to supply the cue data to the SDRAM. The reference numeral 6B designates a FIFO for storing the cue type QID, the reset flag, and the stop information.

Since the remaining components of FIG. 7 are the same as those the foregoing embodiment 1, the description thereof is omitted here.

Next, the operation of the present embodiment 4 will be described.

When the cue data of the same cue type is to be written into the FIFO 5 successively, the FIFO/RAM write controller 3C supplies the FIFO 6B with the stop information that takes the value zero for the consecutive cue data except for the final cue data, for which it takes the value zero. The stop information is written in conjunction with the cue type and the reset flag. When the cue data of the same cue type does not continue, the stop information of the value one is written.

Causing the FIFO 5 to output the cue data of the same type as a single unit, the controller 24A of the monitoring control circuit 8 controls the back-end processor 7 until the stop information becomes one such that the cue data is read from the FIFO 5 continuously and written into the SDRAM via the back-end processor 7.

Since the remaining operation of the present embodiment 4 is the same as that of the foregoing embodiment 1, the description thereof is omitted here. Besides, although the present embodiment 4 is a variation of the embodiment 1, other embodiments can be modified in the same manner.

As described above, the present embodiment 4 is configured such that when the data of the same type continues in the FIFO 5, the FIFO 6B stores the 1-bit stop information with a predetermined value in parallel with the final cue data of the consecutive cue data as the information about continuity; and the monitoring control circuit 8 continuously reads the cue data and the stop information corresponding to the cue data from the FIFO 5 and FIFO 6B in synchronism until the stop information with the predetermined value one appears from the FIFO 6B. Thus, the present embodiment 4 offers an advantage of being able to determine the cue data to be continuously read from the FIFO 5 by only increasing the number of bits of each word of the FIFO 6B by one, thereby facilitating the optimization of the processing.

As for the individual portions of the embodiments 1-4, they are not limited to those described above, but any equivalent circuits are also applicable. Furthermore, the number of the cue types, the number of words and the number of bits of the word of the FIFOs 5, 5A, 6, 6A and 6B are not limited to those described above.

What is claimed is:

1. A data processor for temporarily storing a plurality of types of data transmitted, and for outputting stored data of each type as a single unit, said data processor comprising:
first storing means for storing the plurality of types of data in a predetermined order;
second storing means for storing information about the type of the data and information about continuity of data of a same type in parallel with the data stored in said first storing means;
control means for reading a plurality of data of the same type continuously from said first storing means in response to the information stored in said second storing means; and
output means for outputting the data read by said control means as a single unit.

2. The data processor according to claim 1, wherein said control means reads the information about the type of the data and the information about continuity of the data of the same type from said second storing means in an order stored, and subsequently reads the data corresponding to the information about the type of the data and the information about continuity of the data of the same type from said first storing means in response to the information read from said second storing means.

3. The data processor according to claim 1, wherein
said first storing means stores, when reset information indicating a data type to be discarded is detected from the transmitted data, the reset information successively;
said second storing means stores a reset flag with predetermined value in correspondence with the reset information; and
said control means starts, when the reset information is detected from the transmitted data, to discard the data of the type specified by the reset information, reads from said second storing means the information about the type of the data, the information about continuity of the data of the same type and the reset flag in the order stored, reads the data and the reset information from said first storing means in the order stored, reads, when reading the reset flag with the predetermined value from said second storing means, the reset information from said first storing means in synchronism with the reading of the reset flag from said second storing means, and completes discarding the data of the type specified by the reset information read from said first storing means.

4. The data processor according to claim 1, wherein
said second storing means successively stores, when reset information indicating a data type to be discarded is detected from the transmitted data, the data type to be discarded and a start flag of a predetermined value in an order; and
said control means starts, when the reset information is detected from the transmitted data, to discard data of the type specified by the reset information, reads the information about the type of the data, the information about continuity of the data of the same type and the start flag from said second storing means in the order stored, and completes, when the start flag of the predetermined value is read from said second storing means, discarding the data indicated by the information about the type of the data read in conjunction with the start flag.

5. The data processor according to claim 1, wherein
said first storing means stores, when reset information is detected in the transmitted data, a portion of the reset information in a predetermined order as a one word;
said second storing means stores a reset flag ID indicating a position of the portion of the reset information in the reset information; and
said control means starts, when the reset information is detected from the transmitted data, to discard the data of the type specified by the reset information, reads from said second storing means the information about the type of the data, the information about continuity of the data of the same type, the reset flag and the reset flag ID in the order stored, reads the data and the reset information from said first storing means in the order stored, reads, when reading the reset flag with the predetermined value from said second storing means, the portion of the reset information from said first storing means in synchronism with the reading of the reset flag from said second storing means, and completes discarding the data of the type specified by the portion of the reset information read from said first storing means and the reset flag ID.

6. The data processor according to claim 1, wherein
said second storing means stores, when same type data continue in said first storing means, a number of consecutive data in parallel with the data as information about continuity; and
said control means reads the number of data from said second storing means, and reads the data by the number of data continuously from said first storing means.

7. The data processor according to claim 1, wherein
said second storing means stores, when same type data continue in said first storing means, stop information of a predetermined value in parallel with final data of the consecutive data as information about continuity; and
said control means reads data and stop information corresponding to the data from said first storing means and said second storing means in synchronism, respectively, and reads the data from said first storing means continuously until the stop information of the predetermined value is read from said second storing means.

8. The data processor according to claim 1, wherein said first storing means and second storing means each consist of a FIFO.
